(19) United States
(12) Patent Application Publication
(10) Pub. No.: US 2019/0299165 A1
(43) Pub. Date: Oct. 3, 2019

(54) FEED PREPARATION OF FCC SLURRY OIL RETENTATE FOR DOWNSTREAM PROCESSING

(71) Applicant: Cat' Fine Management Technologies, LLC, Liberty, TX (US)

(72) Inventor: Larry J. WEBER, Liberty, TX (US)

(21) Appl. No.: 16/370,356

(22) Filed: Mar. 29, 2019

Related U.S. Application Data
(60) Provisional application No. 62/761,577, filed on Mar. 30, 2018.
(60) Provisional application No. 62/761,765, filed on Apr. 6, 2018.

(51) Int. Cl. B01D 65/06; C10G 55/06; B01D 65/02; C10G 57/00; C10G 53/04

(52) U.S. Cl. CPC B01D 65/06; C10G 55/06; B01D 65/025; B01D 2321/16; C10G 53/04; B01D 2321/04; B01D 2321/02; C10G 57/00

(57) ABSTRACT

A method for preparation of FCC slurry oil retentate for downstream processing while simultaneously cleaning catalyst fine retentate from filter elements or separation media of a filter assembly of an FCC slurry oil filtration system includes front-washing the filter or separation media with a low boiling point solvent, and then backwashing the filter elements with the same solvent. The front wash and backwash is conducted at a temperature of below 350° F. and at a pressure of about 25-75 psig.

### CROSS-REFERENCE TO RELATED APPLICATIONS

This application claims priority to U.S. Application No. 62/761,577 filed Mar. 30, 2018 entitled “Frontwash Purification of the SORDS or Slurry Oil Storage Tank Bottoms Filtration Systems” and to U.S. Application No. 62/761,765 filed Apr. 6, 2018 entitled “Filtrand Cleansing & Backwash of the SORDS or Slurry Oil Storage Tank Bottoms Filter Retentate”, both of which are is incorporated herein by reference.

In addition, this application is related to Weber, U.S. Pat. No. 9,605,214 and US Pub. No. 20170036201, both of which are also incorporated herein by reference.

### TECHNICAL FIELD

The present invention relates to a method for preparing inorganic fluid catalytic cracking (FCC) catalyst solids and residual slurry oil contained on the surface and in the pores of FCC slurry oil retentate filtered or separated from FCC slurry oil for downstream processing. The contaminating FCCU catalyst is filtered by porous metal elements or screen mesh of varying sizes or separated by electrostatic attraction of catalyst particles onto a charged media. This filtrand (i.e., catalyst particles) is a listed hazardous waste, named K-170, as defined by the U.S. Resource Conservation and Recovery Act (RCRA).

In particular, the invention relates to a method for preparing the two components of FCC slurry oil retentate, i.e. FCC slurry oil and FCC catalyst, for downstream processing.

### Abbreviations

The following abbreviations are used throughout this disclosure, and in the appended claims.

| | |
|---|---|
| APS | Average Particle Size |
| FCC Cat' Fines | Small catalyst particles resulting from impact and |
| | abrasion in the FCC process |
| CSO | Cat' Slurry Oil |
| Cat' | Catalyst |
| Cat' cracker | Fluid Catalytic Cracking Unit (FCC) |
| FCC | Fluid Catalytic Cracker |
| FCC-CFD | Fluid Catalytic Cracking - Catalyst Fine Desalting |
| FCCU | Fluid Catalytic Cracking Unit |
| LBPS | Low Boiling Point Solvent |
| LBPSE | Low Boiling Point Solvent Extraction |
| LCO | Light Cycle Oil produced from FCCU Processing |
| RCRA | Resource Conservation and Recovery Act |
| Mobilization | Any hydrocarbon diluent, typically FCC LCO, used to |
| Diluent | enhance recovery and mobilization of SOCFBs |
| SOCFBs | FCC Slurry Oil Catalyst Fine Bottoms |
| SORDS | FCC Slurry Oil Run-Down Stream |
| Catfeed | FCCU feedstock typically having a high paraffinic |
| | content and which is susceptible to cracking of paraffinic |
| | carbon-carbon bonds |
| HCO | Heavy Cycle Oil from FCC Processing |

### BACKGROUND

The problems presented by catalyst attrition from Fluid Catalytic Cracking Units (FCCUs) have plagued the refining industry since the advent of fluid catalytic cracking in the first half of the 20th century. The first commercial processing by the Fluid Catalytic Cracking method occurred on May 25, 1942. Over time, FCCU catalysts deteriorate in size. The size deteriorated catalysts are commonly referred to as “cat′ fines”. For seven decades the petroleum refining industry has dealt with this issue in the same manner, i.e. “Let it make its way to the FCC slurry oil storage tank and get it later”. This practice has presented deleterious economic and environmental consequences not the least of which include health threatening issues associated with human entry into FCC slurry oil storage tanks. Thus, there has been a long-felt need for an economically feasible solution to the slurry oil problem.

In the FCC process, cracked product stream vapor and some catalyst, typically of small particle size vis-à-vis the average particle size (APS) of new catalyst, escape the FCCU via the reactor cyclones, leave the reactor, and enter the main fractionating tower near its base. The fractionating tower bottoms stream from the FCC fractionator is called FCC slurry oil. The term “FCC slurry oil” has arisen as a result of the presence of catalyst particles in the distillation tower bottom's product. The FCC slurry oil is not a typical slurry, as slurries are commonly known. In rubbing a drop of FCC slurry oil between the forefinger and thumb (with protective gloves), only a very slight grittiness can be detected even by an experienced technician. FCC Slurry Oil is distinct and dramatically different from, for example, hydrocracker slurry oil in the chemical composition of both the hydrocarbon component and the suspended catalyst that contaminates the hydrocarbon component. As such, methods of treating hydrocracking slurry oils, disclosed in references such as DaCosta, US Pub. Nos. 20090163348 and 20090159505, offer no insight into how to best treat FCC slurry oil.

The cat′ fines in the produced FCC slurry oil are typically present in the FCC slurry oil at a low concentration of 0.08% to 0.15% (800 ppm to 1500 ppm) under optimum processing conditions. This concentration has been observed to be as high as 6000 ppm (0.6%) in atypical cases. It is normal that, over the run of the FCCU, the volume of cat′ fines that escape the FCC reactor increases as a result of cyclone deterioration. Cat′ fines first make their way to the FCCU fractionating tower where, as inorganic non-volatile solids, they cascade down the tower and leave the tower as a contaminant of the hydrocarbon bottoms product of the FCCU process (i.e., a contaminant in the FCC slurry oil). Ultimately the cat′ fine particles make their way to the FCC slurry oil product storage tank. Once in the storage tank, the cat′ fines settle to the storage tank bottom, albeit very slowly. This “innocuous” suspension of cat′ fine particles in the FCC slurry oil run-down stream, albeit at first-glance almost undetectable, results in significant accumulation of FCC slurry oil cat′ fine bottoms (hereinafter referred to as SOCFBs) in FCC slurry oil storage tanks. A typically sized cat′ cracker will produce one half to one and one half US tons (i.e., 1000 lbs. to 3000 lbs.) of FCC catalyst, present in the FCC slurry oil as cat′ fine contamination, each day.

### Implications of FCC Cat′ Fine Contamination of FCC Slurry Oil

FCC slurry oil is a saleable product of FCC processing. However, the existence of catalyst fines in the FCC slurry oil product and ultimately as SOCFB's in the FCC slurry oil storage tank presents a variety of problems to the refiner. The immediate problem has to do with product quality. FCC slurry oil has proven to be an ideal feedstock for carbon black and needle coke manufacture. Utilization as carbon black or needle coke feedstock dramatically increases the value of FCC slurry oil product. However, the presence of catalyst fines above a specified percentage in the FCC slurry oil product results in an “ash content” in excess of the specification which is acceptable for use of the FCC slurry oil as a feedstock for the manufacture of either carbon black or needle coke. Even when the FCC slurry oil product is utilized as a lower valued fuel source, a “price penalty” is levied as ash content in the form of the inorganic catalyst fines increases. The typical FCC slurry oil product specification for cat′ fines is less than 400 parts per million (or less than 0.04%) for use as feedstock to manufacture carbon black, and only 100 ppm (or 0.01%) for use as feedstock to manufacture needle coke.

Firms within the specialty chemical industry that service the petroleum refining industry have built proprietary product lines designed to enhance settling of the catalyst fines in the FCC slurry oil storage tank. This is no more than a “band-aid fix”. In recently or relatively recently cleaned storage tanks, some of these procedures can be successful in enabling the stored FCC slurry oil product to meet the specifications of carbon black or needle coke manufacturers for a period of time. However, as the accumulation of catalyst fines continues in the storage tank, a time comes when no amount of settling enhancement will permit the stored product to “meet specification” of carbon black or needle coke manufacturers or even fuel products.

A third factor that compels the control of SOCFB accumulation has to do with storage tank inspection criteria. Regulatory authorities require storage tank inspection at specified intervals. The presence of SOCFB's interferes with these inspections.

In 1998, FCC slurry oil cat′ fine bottoms were listed by the United States Environmental Protection Agency (USEPA) as a hazardous waste under provisions of the US Resource Conservation & Recovery Act and were labeled K-170. The cost of disposal of SOCFBs immediately increased from $27.50 per ton to over $400 per ton when the regulation was enacted. Currently, disposal cost can be as high as $900 per US ton. FCC catalyst fines backwashed from the FCC slurry oil run-down stream (SORDS) by various filtration or separation hardware systems fall under the auspices of the RCRA K-170 listing.

### FCC Slurry Oil/Catalyst Fines Tank Bottoms Recovery & Processing

When accumulation of catalyst fines in the FCC slurry oil storage tank becomes intolerable, in terms of meeting product specification or inspection criteria, refinery management schedules a clean-out. The clean-out is typically conducted under one of two scenarios. One type of clean-out, referred to as a “partial clean-out”, calls for the removal of the catalyst fines without human entry. In this instance, enough of the catalyst fine sediment is removed to reduce the level of accumulation in the storage tank and thus allow for enough settling room to enable the FCC slurry oil product to meet specification guidelines.

There are refineries, typically those with large production cat′ crackers (100,000 BPD or more), that conduct a never-ending partial FCC slurry oil storage tank clean-out exercise. The procedure is as follows: allow the cat′ fines to settle in the storage tank, retrieve the cat′ fines from within the slurry tank, process the retrieved cat′ fines to a hazardous waste non-conclusion, and start again the next day or next week. A 100,000 barrel per day (BPD) cat-cracker will generate the equivalent of about 0.7 U.S. ton (UST) per day of cat′ fine solids under optimum operating conditions. This equates to about 1.4 US tons of SOCFBs per day.

The second type of clean-out, commonly referred to as a FCC slurry oil storage tank turn-around, entails a complete removal of all catalyst fine sediment in the form of SOCFBs, subsequent human entry for rigorous clean-up and a so-called mop-up, all followed by inspection, repairs and return-to-service. It is a tedious, dangerous and health threatening exercise replete with potential human exposure to aromatic vapors.

The low API gravity/high density of the FCC slurry oil coupled with the entrained catalyst fines contributes to recovery and handling problems that are reputed to be some of the toughest in the tank cleaning industry. The tank cleaning industry has devised a number of procedures for catalyst fines removal from FCC slurry oil storage tanks. These include the injection of diluent at high pressure either via side ports or from the roof of the storage tank, the cutting of “door sheets” using a water torch and various probe insertion devices, etc. One such insertion device was co-invented by the present inventor and is called the SWEEPBER and is described in U.S. Pat. No. 6,142,160, which is incorporated herein by reference. As described therein, the SWEEPBER insertion device serves the purpose of recovering catalyst fines from the bottom of FCC slurry oil storage vessels without human entry.

A diluent is generally required to enhance ease of handling of the SOCFBs. The observed and preferred diluent of choice is FCC Light Cycle Oil (LCO), a side-cut of the FCCU fractionator. The use of LCO, a valuable finished product, as a diluent is extremely costly and can be the single largest cost associated with the resolution of accumulated cat′ fines in FCC slurry oil storage tanks. Annualized, this will translate to a cost of about $1 million per year. As discussed below, my new method recovers the vast majority of LCO in the case of SOCFB processing.

### Prior Methods for Filtration of the FCC Slurry Oil Run-Down Stream

The obvious solution to both FCC slurry oil storage tank SOCFB accumulation and meeting premium product specification is to decontaminate the FCC slurry oil by filtering or separating the catalyst from the FCC slurry oil run-down stream (SORDS) before delivery of the slurry oil to a storage tank. Within the last 20 years, after some 50 years of the “let it make its way to the storage tank and get it later” strategy, SORDS filtration systems have gained some popularity with the petroleum refining industry. Two of the more effective methods presently utilized in global refineries are porous metal filtration and electrostatic attraction. There are other approaches but all experience the issue of dealing with backwashed catalyst retentate, categorized as K-170, from the respective filtration or separation system.

### Prior Methods of Backwashinq SORDS Decontamination Assemblies

The current method of backwashing SORDS filtrand is to employ hot FCC slurry oil, hot FCC heavy cycle oil, hot catfeed, or hot FCC light cycle oil; hot being the operative and emphatic adjective. FCC catalyst fines are typically filtered or electrostatically separated from FCC slurry oil at a temperature in excess of 450° F. (about 230° C.), and as high as 550° F. (about 290° C.). FCC cat′ fine filtration or separation assemblies are typically positioned along the FCC slurry oil run down stream as far upstream toward the fractionator as possible in order to take advantage of the high exit temperature characteristic of the FCC fractionator bottoms. The industry standard for the temperature at which filtration or separation of FCC catalyst contamination occurs is “the higher the better”. FCC slurry oil, at ambient temperatures, is at least highly viscous and at worst a waxy-type solid. Likewise, FCC HCO and FCC catfeed is highly viscous. FCC LCO is less viscous but backwashing with LCO is, nevertheless, enhanced by higher temperature. To filter/separate at lower temperatures would be the equivalent of filtering talcum powder from cold molasses.

### Current & Prior Practices for Disposition of Backwash Streams

One current method for dealing with SORDS filtrand/retentate backwash is to recycle the SORDS filtrand/retentate into the feed to the FCCU. This may be done with any of the four previously described backwash hydrocarbons. Since the backwash FCC slurry oil has already been cracked by the FCC process and since the catalyst constituent of the backwash is rendered inactive by a patina of coke; there is no benefit to be had from the recycled catalyst unless the catalyst is regenerated. That is why the FCC process calls for regeneration of reactor-side catalyst. Under the above-described method, non-active catalyst particles displace active, regenerated catalyst thereby reducing overall conversion in the FCCU. Likewise, under the above-described method, if FCC slurry oil, FCC HCO, or FCC LCO is used as the backwash diluent, then “crackable” catfeed is backed-out and displaced by “cracked-out” FCC slurry oil. This displacement translates to an economic cost that can easily exceed $1 million per year in lost fresh catfeed processing.

A second method of disposition of the backwash mixture is to simply backwash to a storage reservoir. Subsequently the K-170 backwash mixture is transported away. Alternative disposition sites include landfill, cement kiln feedstock, or an incinerator.

There is a third method for dealing with the backwash mixture which includes integrating the method described in my U.S. Pat. No. 9,605,214 which is incorporated herein by reference.

### Closing the Environmental Loop on Recovered Catalyst

Weber, U.S. Pat. No. 9,605,214, describes a method for producing dry, unregenerated catalyst that can be injected into the FCCU, preferably just upstream of the regenerator. This reclaimed catalyst, once regenerated, bears the activity of equilibrium catalyst or “E-Cat” because that is precisely what it is. There are presently two preferred disposition options available as a “closing of the loop” for the catalyst component of the SORDS filtrand/retentate. The ideal option is to reinject the reclaimed catalyst, once dried and amenable to handling by conventional FCC pneumatic transport systems for FCC catalyst, into the FCCU at a point just upstream of the regenerator. Any reinjected, reclaimed catalyst that attrites via the regenerator cyclones and scrubber system is rendered non-hazardous as a result of the combustion of aromatic hydrocarbons while off-setting makeup catalyst requirements as a result of both “metal flushing” and some increased cycling of the equilibrium catalyst. The recycling into the FCCU option is invited when the reclaimed catalyst is provided in a dry powdered form amenable to existing pneumatic transport and handling systems characteristic of present day FCCUs

An ideal situation occurs when an opportunity to cascade recovered catalyst to an alternate FCCU is presented. This occurs when there is significant differential, in terms of lesser catalyst activity requirement, between the reclaimed catalyst and the equilibrium catalyst typical of an alternate FCCU which requires less stringent catalyst activity.

A second industry-accepted option for recovered catalyst disposition is as a cement kiln feedstock while still suspended in the hydrocarbon used as backwash. The primary chemical constituents of FCC catalyst are the oxides of silica and aluminum; the very same primary components of typical cement kiln feed. Catalyst reclaimed by the K-170 Resolution method of my noted U.S. Pat. No. 9,605,214 is especially qualified for this option because of the form in which it is reclaimed, i.e. as a free-flowing powdered material capable of being handled by standard cement kiln pneumatic systems. Alternatively, FCC filtrand from in-line filtration systems located along the slurry oil run down stream (SORDS) that has been backwashed by conventional existing methods, i.e. backwash with either FCC slurry oil, FCC Heavy Cycle Oil or FCC Light Cycle Oil, exists as a mixture of FCC Catalyst, residual FCC Slurry Oil and the backwash hydrocarbon liquid. This mixture is then disposed in whole as feed to the cement kiln. Unfortunately for the refiner, in the case of currently practiced backwash procedures, the catalyst filtrand is suspended in the backwash hydrocarbon at a typical concentration of 5% to 10%. The result is that the refiner not only disposes of valuable slurry oil or LCO that has been used as the backwash hydrocarbon but the refiner pays some 10× to 20× the shipping and volume cost of the backwash mixture in the form of FCC catalyst fines suspended in FCC HCO, FCC LCO or FCC slurry oil. Furthermore, cement kiln operators charge refiners for accepting K-170 waste be it in the form of an oily cake, dry catalyst or other alternative forms such as K-170 backwash which contains 90% plus hydrocarbon that the cement kiln operator not only receives free of charge but also charges for its acceptance! As discussed below, dry FCC catalyst reclaimed by my new method, disclosed below, contains only minimal amounts of residual FCC slurry oil hydrocarbon which, nevertheless, serves to subsidize the BTU requirements of the cement kiln free of charge.

### Historical & Current Method of Backwash for in-Line FCC SORDS Filtration Systems

The filtration of FCC slurry oil is necessarily accomplished at relatively high temperatures. Those of ordinary skill in the art of FCC slurry oil filtration know that, “The higher the temperature the better”. The conventional wisdom is that temperatures below 450° F. are considered to be disadvantageous to effective FCC slurry oil filtration or separation. Likewise, backwash of in-line slurry oil filtration systems is conducted at high temperatures, i.e. in the range of 450° F. and preferably above 500° F. The high temperature requirement is known in the art of FCC slurry oil filtration/separation and backwash because, below 450° F. the viscosity of slurry oil increases such that filtration cannot be effectively performed. Likewise, below 450° F. backwash with the hydrocarbons of choice under current practice (i.e., HCO, LCO and FCC slurry oil) cannot be effectively performed. When periodic backwash of in-line FCC slurry oil filtration systems is required, high boiling point hydrocarbon liquids—not notable for their solvency of asphaltenes—are used. I am currently unaware of the use of any backwash liquids, used for in-line FCC slurry oil filtration systems, other than hot FCC heavy cycle oil (HCO) hot FCC light cycle oil (LCO), hot FCC slurry oil or hot FCC catfeed.

### SUMMARY

Briefly, a method for preparing FCC slurry oil retentate for downstream processing while simultaneously removing catalyst fines retentate from filter elements of a filter assembly of a slurry oil filtration system is disclosed. The method comprises front washing the filter elements of the filter assembly by passing a low boiling point solvent (LBPS) from an upstream side of the filter assembly through the filter elements to a downstream side of the filter assembly, and then, back washing the filter elements with the LBPS. The LBPS has a boiling point at atmospheric pressure of less than 300° F.

The use of low boiling point solvents (i.e., solvents with a boiling point, at atmospheric pressure, below about 300° F.) as a backwash medium has never been performed in a commercial application relative to in-line FCC slurry oil filtration or separation systems. There are at least three reasons for this. First, the in-line FCC slurry oil filter housing and internals operate at a temperature which will result in immediate flashing of low boiling point solvents upon introduction into the filter housing. Secondly, low boiling point solvents characteristically are of much higher price than either FCC HCO, FCC slurry oil, FCC LCO, or FCC catfeed. In the case of the backwash “disposal option” the result of backwashing with a low boiling point solvent is that the refiner would be “throwing away” valuable solvent vis-à-vis less desirable HCO, LCO or FCC slurry oil. Likewise, it would be economically frivolous to reinject in-line FCC slurry oil backwash, conducted with valuable low boiling point solvent, into cat feed destined for FCCU riser temperatures (600° F. or more).

Some aspects of the method disclosed in my U.S. Pat. No. 9,605,214 may be coupled with the backwash method described below. The preferred LBPS is, but is not limited to, dimethyl formaldehyde, which is the same solvent named in my noted Pat. No. U.S. Pat. No. 9,605,214. However, in my new method, disclosed below, the low boiling point solvent (LBPS) is employed both as a front-wash liquid and a backwash liquid. This is distinct and goes contrary to current practices which employ, hot HCO, hot LCO, hot FCC slurry oil, or hot FCC catfeed only as a backwash stream. The backwash mixture of the present method (comprising catalyst, LBPS and any residual FCC slurry oil) is sent downstream for processing in a liquid-solid separator of any type, such as an evaporator, including but not limited to a hollow flight dryer or a Ross Vertical Cone. The front-wash mixture of the present method (comprising LBPS and any residual FCC slurry oil flushed by the front wash solvent from the filter or separator housing and retentate) is sent downstream for processing in any type of liquid-liquid separator, including but not limited to a fractionation or separation tower or a reboiler loop coupled with an overhead and associated condensers.

The downstream processing of FCC catalyst fine filtrand/retentate, prepared by the present method, results in a dry FCC catalyst powder amenable to handling by conventional pneumatic transport systems at a superior level of engineering efficiency and economic prudence vis-à-vis current and historical practice. This can be important in closing the environmental loop on the filtrand/retentate which would otherwise remain listed as a hazardous waste under RCRA.

Briefly, the method for feed preparation and simultaneously removing catalyst fines retentate from filter elements of a filter assembly of a slurry oil filtration system comprises front washing the filter elements of the filter assembly by passing a low boiling point solvent (LBPS) from an upstream side of said filter assembly through said filter elements to a downstream side of said filter assembly, the LBPS having a boiling point at atmospheric pressure of less than 300° F.; and then, back washing the filter elements with the same LBPS.

In accordance with an aspect of the method, the LBPS can be petroleum ether, methylene chloride, chloroform, or dimethyl formaldehyde.

In accordance with an aspect of the method, prior to the front washing step, pressurized filtered slurry oil is introduced into the upstream side of said filter assembly to force unfiltered slurry oil through the filter elements and to the downstream side of said filter assembly. The filtered slurry oil can be introduced into the filter assembly at a pressure, for example, of about 25 psi to about 75 psi.

In accordance with an aspect of the method, the downstream side of the filter assembly is drained prior to carrying out the step of front washing with LBPS. The upstream side of the filter assembly can, if desired, also be drained of the filtered slurry oil that was introduced into the filter assembly.

In accordance with an aspect of the method, the filter assembly is cooled to below 350° F., and preferably to about 300° F. or even lower, prior to said front washing step.

In accordance with an aspect of the method, the filtered slurry oil that is introduced into the filter assembly is at a temperature of between about 250° F. and about 350° F. Thus, the cooling step can be accomplished via this step.

In accordance with an aspect of the method, after the step of front washing the filter elements is completed, the filter elements will be substantially submerged in LBPS. The backwashing step comprises forcing the LBPS remaining in the downstream side of the filter assembly through the filter elements to the upstream side of the filter assembly. This backwashing step can include an initial step of pressurizing the filter assembly with a gas, such as an inert gas, such as nitrogen. The filter assembly can be pressurized to about 25 psig to about 75 psig, and preferably about 55 psig to 75 psig.

In accordance with an aspect of the method, the backwash mixture is sent to an evaporator for the purpose of evaporating and reclaiming the solvent and drying the reclaimed FCC Catalyst component of the retentate.

### DESCRIPTION OF THE FIGURES

FIG. 1 is a schematic of a FCC slurry oil filtering system; and

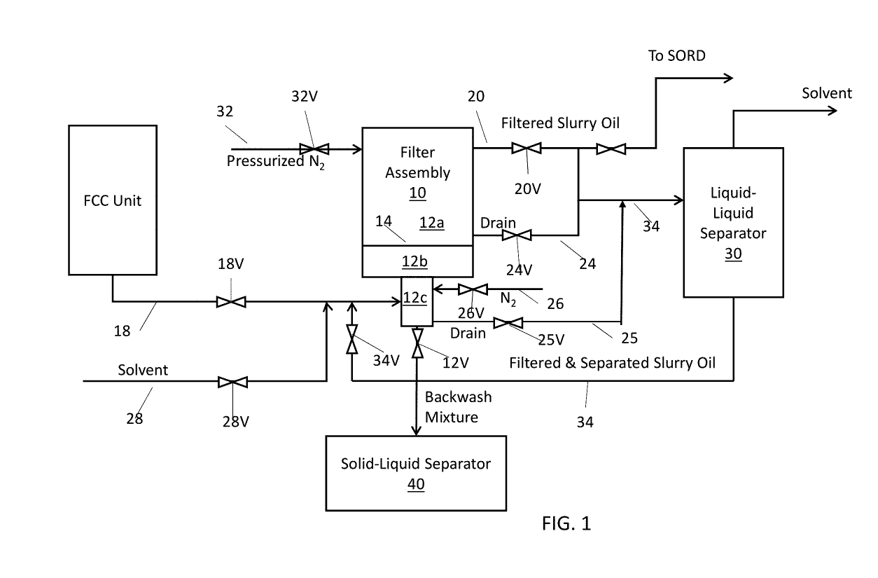

FIG. 2 is a schematic representation of a front wash filtration or separation assembly of the filtering system for use with the disclosed method.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

It will be appreciated that, in a typical FCC system, the slurry oil run downstream from a fluid catalytic cracking unit will be directed to a filtering stage where contaminants are filtered from the slurry oil stream. The filtration of the slurry oil stream is conducted as a continuous process. As can be appreciated, over time, the filter will become clogged with retentate, and will need to be cleaned. Thus, a typical filtering stage comprises a plurality of filter assemblies 10 and appropriate valving and valving controls which allow a filter assembly to be taken off line when its filter element is clogged and which directs that contaminated slurry oil stream to a filter assembly which is not currently clogged, and is available for filtering. In a typical slurry oil filtration system, the flow of slurry oil to the clogged filter assembly will be “throttled down,” and an awaiting, clean filter assembly, to which the flow of slurry oil will be redirected, is “throttled up,” thereby providing a fluent transition of the slurry oil stream from the clogged filter assembly to the clean filter assembly.

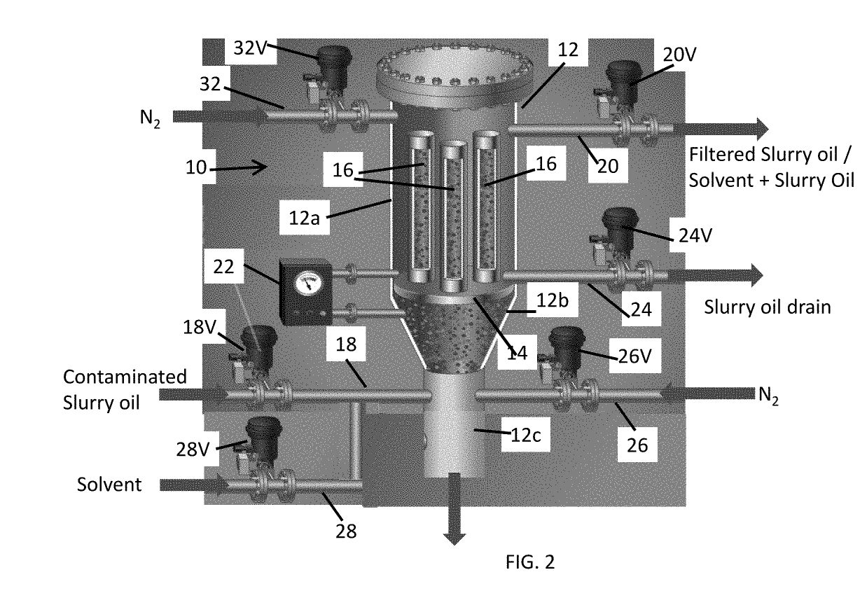

A typical filter assembly 10 (shown in more detail in FIG. 2) includes a housing 12 having a tubesheet 14 with a plurality of filter elements 16 extending upwardly from the tubesheet. For example, a filter assembly that is 36″ in diameter can have up to 120 filter elements. The tube sheet 14 and filter elements 16 divide the interior of the housing 12 into an upstream side (the volume below the tube sheet and within the filter elements) and a downstream side (the volume above the tube sheet outside of the filter elements). As seen in FIG. 2, the housing 12 has a cylindrical portion 12a above the tube sheet and an inverted conical portion or heel 12b below the tube sheet. A neck 12c depends from the bottom of the housing heel 12b.

During normal filter operation, contaminated FCC slurry oil stream enters the filter assembly 10 via an inlet line 18 on the upstream side of the housing (i.e., below the tube sheet). The contaminated slurry oil is forced upwardly through the filter elements 16, and filtered (clean) slurry oil exits the filter assembly on the downstream side of the housing through an outlet line 20 near the top of the housing 12. Contaminants are trapped by the filter elements 16 as the filtrand/retentate. The filtrand/retentate is generally catalyst particles, but can include some asphaltenes. During normal operation, the filtered slurry oil can be collected in a slurry oil storage tank (not shown) or directed back to the slurry oil run down stream en route to the slurry oil product storage tank. As filtrand cakes on the surface of the filter elements, a pressure drop occurs on the downstream side of the tube sheet, and the pressure differential between the upstream and downstream sides of the tube sheet increases. The pressure differential is monitored, for example by a pressure differential gauge 22 which is in communication with both the upstream and downstream sides of the housing. Any desired means could be used to monitor the pressure differential between the two sides of the housing. For example, pressure sensors in each side of the housing to send output to a receiver (such as a PLC computer) which then compares the output of the two sensors. When the pressure difference (AP) between the upstream and downstream sides of the filter assembly reaches about 60 PSI, it is time to take the filter assembly off line and clean the filter elements. At this point, about 0.25″ (about 6 mm) of catalyst fines will have been deposited on the filter elements, and the efficiency of the filter assembly has been reduced enough that it is time to initiate a wash cycle, to remove the filtrand from the filter elements.

Initially, the filter assembly 10 is shut (throttled) down, so that the flow of slurry oil to the filter assembly will ultimately cease. This is accomplished by a measured closing of a valve 18V in the slurry oil feed pipe. As noted above, while the filter assembly 10 is being throttled down, a cleaned filter assembly is being throttled up for use. As the valve 18V is being closed, a corresponding valve in the inlet line of the clean filter is being opened, so that slurry oil will be redirected to this clean filter assembly to filter the slurry oil of catalyst and, if present, asphaltenes.

Subsequently, clean slurry oil from a liquid-liquid separator 30 is introduced into the upstream side of the filter assembly. Preferably, recycled clean (filtered) slurry oil is introduced into the upstream side of the filter assembly through a line 34 which, for example, can join the inlet line 18 downstream of the valve 18V. A valve 34V in line 34 is opened to permit the flow of the recycled (filtered and separated) slurry oil into the inlet line 18. The clean (filtered) slurry oil is introduced at a pressure of about 25 psi to about 75 psi, and preferably about 50 psi. The high pressure of the recycled slurry oil will, in effect, push the contaminated slurry oil (from the FCCU) that is in the heel 12b (downstream side) of the filter assembly up through the filter elements 16. Sufficient clean slurry oil is pumped into the upstream side of the filter assembly such that the upstream side of the filter assembly contains substantially only clean recycled slurry oil. Substantially all of the contaminated slurry oil will be pushed though the filter elements 16 to the downstream side of the filter assembly.

Once the contaminated slurry oil from the upstream side of the filter assembly has been pushed through to the downstream side of the filter assembly, the downstream side of the filter assembly is drained. This is accomplished by opening a valve 24V in a drain line 24. The drain line 24 is proximate (and above) the tube sheet 14, so that the slurry oil in the downstream side of the filter assembly will be drained under the force of gravity. A pump can be used to aid in draining of the slurry oil from the downstream side of the filter assembly. Draining of the housing can also be facilitated by pumping an inert gas, such as nitrogen, into the filter assembly through a gas feed line. This gas, which is used for draining, can be pumped into the filter assembly either on the upstream side through a gas line 26 or downstream side through a gas line 32. The gas lines 26 and 32 include valves 26V and 32V, respectively, and the appropriate valve is opened to allow the gas to enter the filter assembly. The gas will displace the slurry oil in the downstream side of the filter assembly to force the slurry oil out through the slurry oil drain line 24. If the gas is introduced from the upstream side of the filter assembly, it can push some of the residual slurry oil in the filter assembly through the filter assembly to be drained through the drain line 24.

Once the contaminated slurry oil in the upstream side of the filter assembly has been pushed through to the downstream side of the filter assembly, the upstream side of the filter assembly will be filled substantially with the clean, filter slurry oil. If desired, the upstream side of the filter assembly can be drained of the clean filtered slurry oil through a line 25 and valve 25V. Inert gas can be used to facilitate draining the upstream side of the filter assembly in the same manner as in the step of draining the downstream side of the filter assembly. The cleaned slurry oil drained from the upstream side of the filter assembly will be directed to the liquid-liquid separator 30.

As is known, the contaminated slurry oil which enters the filter assembly from the FCC unit is quite hot, on the order of 450° F. to 550° F. (about 230° C. to about 290° C.). As discussed below, the washing method uses a low boiling point solvent (LBPS). Such solvents have boiling points, at atmospheric pressure, in the range of up to at least 175° F., and even up to about 300° F., which is well below the temperature of the slurry oil, and hence well below the temperature in the filter assembly 10 during normal filtration operation. For example, the low boiling point solvent can be dimethylformaldehyde, petroleum ether, chloroform, or methylene chloride (which have a boiling points, at atmospheric pressure, of about 136° F., about 108-144° F., about 142° F., and about 103° F., respectively). Thus, it is necessary to cool the filter assembly 10 to prevent flashing of the LBPS. The recycled slurry oil is at a temperature of between about 250° F. and about 350° F., and preferably about 300° F. The introduction of the recycled slurry oil will cool the filter assembly 10 down from the 450° F. to 550° F. of slurry oil coming from the FCC unit to approximately 300° F. The use of the recycled slurry oil thus accomplishes two purposes—pushing the contaminated slurry oil from the upstream side of the filter assembly through the filter elements to the downstream side of the filter assembly and simultaneously cooling the filter assembly. Other means can be used to cool the filter assembly. For example, cooling coils that surround (or pass through) the filter housing can be used to cool the filter assembly. Any other means can be used to cool the filter assembly. This cooling step reduces the temperature of the filter assembly and, in particular the filter elements, to reduce the temperature in the filter assembly to a point that will prevent flashing of the LBPS upon introduction of the LBPS.

Once the filter assembly has been cooled, a valve 28V in a solvent inlet pipe 28 is opened to allow solvent to flow into and through the filter assembly to start a front wash of the filter elements. The solvent is introduced into the filter assembly at a pressure of about 100 psig to about 250 psig, and preferably about 150 psig to about 175 psig. At these temperature and pressure conditions, the solvent will not flash, and thus will remain in a liquid state. The solvent enters the upstream side of the filter assembly at a ratio of solvent:cake retentate of about 1:1-100:1. The range can be, for example about 1:1-50:1 or about 1:1-25:1 or about 1:1-10:1. As further alternatives, the ratio can be about 5:1-50:1 or about 5:1-25:1 or about 8:1-50:1 or about 8:1-15:1 or about 8:1-10:1 or about 3:1-10:1 or about 4:1-9:1 or about 5:1-8:1 or about 6:1-7:1.

During the front wash, the solvent flows through the filter elements from the upstream side of the tube sheet to the downstream side of the tube sheet and fills the filter housing 12 to a level in which the filter elements 16 are substantially covered. As the LBPS flows through the filter, the LBPS infuses into the pores of the catalyst filtrand to at least partially liberate hydrocarbons contained within the catalyst pores. At a temperature of around 300° F. and pressure of about 50 psig, it is expected that in excess of 90% (and potentially more than 94%) of the hydrocarbons contained within the catalyst pores will be liberated. The solvent also washes hydrocarbons from the outer surface of the catalyst. The solvent within the downstream side of the housing will thus have hydrocarbons entrained in the solvent. This solvent/hydrocarbon stream will exit the filter assembly through the exit pipe 20 to be delivered to a liquid-liquid separator 30 over a line 34 where the solvent will be separated from the hydrocarbon. The front wash continues until a solvent:filter cake ratio (on a volume:volume basis) of about 4:1 to about 8:1 is achieved. For a 50,000 BPD cat cracker (which produces about 2500 BPD slurry oil run down) this front wash step can take about 40 minutes when solvent is introduced into the filter assembly at about 20 gal/min (at the above noted pressure of about 50 psig). At the end of the front wash, the solvent is not drained from the housing assembly, and thus fills the housing assembly to at least the height of outlet pipe 20. As such, filter elements 16 are substantially submerged in solvent. Importantly, there is a gap between the top of the LBPS in the filter housing and the top of the filter housing. A period of additional time of front washing with cooled solvent may be required to facilitate the next step in the process (the backwashing step) to reduce the system temperature to a level suitable for backwashing

During the front wash, the resolution of the components of the front-washing, i.e. residual FCC slurry oil and solvent, are sent to the liquid-liquid separator 30, as noted above, where the LBPS is condensed and recovered. The recovered solvent can, for example, be recycled to be used as the front wash solvent. The liquid-liquid separator 30 can, for example, be similar to the separator disclosed in my above noted Pat. No. 9605214, which is incorporated herein by reference. Alternatively, the separator 30 can be any type of commercially available separator. The FCC Slurry Oil and/or mobilization hydrocarbon, in the case of SOCFB processing, is recovered from the liquid-liquid separator as a finished refinery product and stored for transport and sale.

After the front wash is completed, the valve 20V in the exit pipe 20 is closed. The valves 24V, 26V, and 28V are also closed. The valve 18V in the inlet line 18 remains closed. In addition, a valve 12V in (or below) the neck 12c is closed as well. Thus, the interior of the filter assembly is essentially isolated. Once the valves are closed, a valve 32V in a gas inlet pipe 32 is opened to introduce an inert gas, such as nitrogen, into the downstream side of the filter assembly. As illustratively shown, the gas inlet pipe 32 is located near the top of the housing 12. Preferably, the gas inlet opens into a gap above the LBPS in the housing 12. As such, the gas inlet line 32 preferably is above the outlet line 20. Gas is pumped into the housing until the pressure within the housing reaches about 50 psig to about 75 psig, and preferably, about 60 psig. At that point, the valve 12V in the neck 12c is opened (preferably quickly), and the gas and solvent flow through the filter elements, from the downstream side to the upstream side to dislodge catalyst retentate from the filter elements 16. This will force the catalyst down into the conical heel portion 12b of the housing, and then into the neck 12c. This backwash step essentially “blows” the solvent and catalyst particles out of the filter assembly through the neck 12c. The resolution of the components of the backwash mixture (i.e. the FCC catalyst retentate, solvent, and any residual FCC slurry oil “blown out” of the filter assembly when the valve 12V is opened) are sent to a solid-liquid separator 40 of any type to separate the solvent from the catalyst particles. For example, the solvent can be separated from the catalyst using a dryer, such as disclosed in my above-noted U.S. Pat. No. 9,605,214, to a vacuum dryer, such as a Ross Vertical Cone dryer, or to a heated dryer, such as a heated hollow flight dryer.

When a sufficient amount of solvent is used during the frontwash of the filter assembly, the resulting catalyst, dried of solvent, will be amenable to transport by typical FCC catalyst pneumatic transport systems. For example, additional solvent will not be necessary if the solvent:catalyst ratio is about 1:1 to about 8:1, preferably about 2:1 to about 8:1, and more preferably about 4:1, by volume.

Although not disclosed, one of ordinary skill in the art will recognize that the disclosed system will also include necessary pumping equipment to move the various solutions through the system.

While the specific embodiments have been described, numerous modifications come to mind without significantly departing from the spirit of the invention and the scope of protection should only be limited by the scope of the accompanying claims.

1. A method for preparing catalyst fines retentate from filter or separation elements of a filter assembly of a slurry oil filtration system for downstream processing while simultaneously removing accumulated retentate from the filter or separation elements; the method comprising:
front washing the filter or separation elements of the filter assembly by passing a low boiling point solvent (LBPS) from an upstream side of said filter assembly through said filter or separation elements to a downstream side of said filter assembly, the LBPS having a boiling point at atmospheric pressure of less than 300° F.; and
then, back washing the filter elements with the same LBPS to dislodge retentate from the filter or separation elements; said backwashing step forming a backwash mixture comprised of the LBPS and dislodged retentate.

2. The method of claim 1 wherein the LBPS is petroleum ether, methylene chloride, chloroform, or dimethyl formaldehyde.

3. The method of claim 1 including a step of draining slurry oil from one or both of the downstream side of the filter assembly prior to carrying out the front washing step.

4. The method of claim 3 including a stop of draining slurry oil from the upstream side of the filter assembly prior to carrying out the front washing step.

5. The method of claim 1 including a step of cooling the filter assembly to below 350° F. prior to said front washing step.

6. The method of claim 1 including a step, prior to said front washing step, of introducing pressurized filtered slurry oil into the upstream side of said filter assembly to force unfiltered slurry oil from the upstream side of the filter assembly, through the filter or separation elements, and to the downstream side of said filter assembly.

7. The method of claim 6 wherein said filtered slurry oil is introduced into said filter assembly at a pressure of about 25 psi to about 75 psi.

8. The method of claim 6 wherein said filtered slurry oil is introduced into said filter assembly at a pressure of about 50 psi to about 75 psi.

9. The method of claim 6 wherein said filtered slurry oil is at a temperature of between about 250° F. and about 350° F.

10. The method of claim 9 including a step of cooling the filter assembly to below 350° F. prior to said front washing step; said cooling step comprising said step of introducing pressurized filtered slurry oil into the upstream side of said filter assembly.

11. The method of claim 6 comprising a step of draining the downstream side of the filter assembly, and optionally draining the upstream side of the filter assembly, after said step of introducing pressurized filtered slurry oil is completed and prior to carrying out the front washing step.

12. The method of claim 1 wherein, after said step of front washing said filter element is completed, said filter elements will be substantially submerged in said LBPS; said step of back washing said filter elements comprising forcing the LBPS in the downstream side of the filter assembly through the filter or separation elements to the upstream side of the filter assembly.

13. The method of claim 12 wherein the backwash mixture is delivered to a solid-liquid separator where the LBPS is separated from the retentate.

14. The method of claim 12, wherein said backwashing step comprises pressurizing said filter assembly prior to forcing the LBPS through the filter elements.

15. The method of claim 14 wherein said filter assembly is pressurized to about 25 to about 75 psi.

16. The method of claim 14 wherein said filter assembly is pressurized using an inert gas.

17. The method of claim 1 wherein the backwash mixture is sent to a solid-liquid separator to separate the LBPS of the backwash mixture from the retentate and to dry to retentate to allow for the reclaiming of the FCC Catalyst component of the retentate.

18. A method for removing catalyst fines retentate from filter or separation elements of a filter assembly of a slurry oil filtration system; the method comprising:
draining a downstream side of the filter assembly;
cooling the filter assembly to below 350° F.;
after the cooling step, front washing the filter or separation elements of the filter assembly by passing a low boiling point solvent (LBPS) from an upstream side of said filter assembly through said filter elements to the downstream side of said filter assembly, the LBPS having a boiling point at atmospheric pressure of less than 300° F.;
then, back washing the filter or separation elements by forcing the same LBPS from the downstream side of the filter assembly, through the filter elements, to the upstream side of the filter assembly; said step of backwashing including pressurizing the filter assembly.

19. The method of claim 18 including, prior to said draining step, a step of introducing pressurized filtered slurry oil into the upstream side of said filter assembly to force unfiltered slurry oil from the upstream side of said filter assembly, through the filter elements, and to the downstream side of said filter assembly.

20. The method of claim 19 wherein said filtered slurry oil is at a temperature of between about 250° F. and about 350° F.; said cooling step comprising said step of introducing the pressurized filtered slurry oil into the filter assembly.
